(19) United States
(12) Patent Application Publication
(10) Pub. No.: US 2007/0133962 A1
(43) Pub. Date: Jun. 14, 2007

(54) Cordless steam cleaner

(76) Inventors: Leandro P. Rizzuto, Sheridan, WY (US); Vito James Carlucci, Stratford, CT (US); Harold Roy Taylor, Stratford, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/583,578

(22) Filed: Oct. 19, 2006

Related U.S. Application Data
(60) Provisional application No. 60/728,393, filed on Oct. 19, 2005.
(60) Provisional application No. 60/782,324, filed on Mar. 10, 2006.

(51) Int. Cl. H05B 3/60

(52) U.S. Cl. 392/324

(57) ABSTRACT

There is provided a reheatable steam-cleaning device (10) that can be used with or without a power cord (30), including a pressure vessel (12) and a power base station (14). The preferred embodiment features a power base station (14) working in conjunction with the steam pressure vessel (12) to allow for a “cord, cordless” system that can eliminate the limitations of a power cord and keep the vessel enclosure (32), water and steam at the proper temperature for an extended period of time for spot cleaning or cleaning in a relatively small area. The vessel enclosure (32), water and steam can be easily reheated for continued use by placing the pressure vessel on a vessel plug (28) located on a support plate (26) of the power base station (14). The power base station (14) also features a locking system that can enable the steam-cleaning device (10) to be used in a continuous operation for large cleaning areas by locking the pressure vessel (12) to the power base station (14).

### CROSS-REFERENCE TO RELATED APPLICATIONS

This application claims priority to U.S. Provisional Application 60/728,393, filed on Oct.19, 2005 and co-pending U.S. Provisional Application 60/782,324, filed on Mar. 10, 2006, the disclosures of which are hereby incorporated herein by reference in their entirety.

### BACKGROUND OF THE INVENTION

1. Field of the Invention

The present invention relates to devices for steam cleaning. More particularly, the present invention relates to a reheatable steam-cleaning device that can be used with or without a power cord.

2. Description of Related Art

It is known to provide devices that can be used to clean objects with steam. A pressure vessel can be used to hold a quantity of water. A heater can be used to heat the water to a temperature sufficient to convert at least a portion of the water to steam. A trigger can then be pressed in order to open a valve, which can then enable the steam to flow out through a nozzle toward an object to be cleaned.

Inherent shortcomings associated with these known devices include the inconvenience of walking through various areas with a power cord attached to the steam cleaner. The power cord can become tangled or can come into contact with other objects and possibly knock them over and/or break them. A user of the steam cleaner can also trip over a long cord. It can also be inconvenient to unplug the steam cleaner when moving to a new area and then have to find a new plug to plug the steam cleaner into.

Thus, there is a need for a steam-cleaning device that enables a user to move to various areas without having to pull a power cord along. There is also a need for a device that provides a user with the option of whether to use the device without a power cord or with a power cord when desired, such as when cleaning large areas. There is further a need to prevent water from spilling out of the pressure vessel when the pressure vessel is tipped to a forward position.

### OBJECT AND SUMMARY OF THE INVENTION

It is an object of the present invention to overcome the shortcomings of the prior art mentioned above. These and other objects are achieved by the present invention described herein.

The present invention achieves these and other objectives by providing a steam pressure vessel and a power base station. The steam pressure vessel can include a body, a handle, a cleaning attachment in the form of a nozzle and a pressure relief valve cap. Located on the handle can be a trigger to enable a user to release steam from the nozzle.

The preferred embodiment features a power base station working in conjunction with the steam pressure vessel to allow for a “cord, cordless” system that can eliminate the limitations of a power cord and keep the vessel enclosure, water and steam at the proper temperature for an extended period of time for spot cleaning or cleaning in a relatively small area. The vessel enclosure, water and steam can be easily reheated for continued use by placing the pressure vessel on the power base station. The power base station supplies power to the heater assembly in order to use water to make steam in the pressure vessel, as well as serving as a steam reheat station and cord holder. The power base station also features either a sphere/ring locking system or a captured locking lever cam system that enables the steam-cleaning device to be used in a continuous operation for large cleaning areas by locking the pressure vessel to the power base station.

### BRIEF DESCRIPTION OF THE DRAWINGS

The present invention is more fully understood by reference to the following detailed description of an illustrative embodiment with the drawings identified below.

FIG. 1 is a perspective view of a steam-cleaning device in accordance with a preferred embodiment of the present invention.

FIG. 2 is a schematic cross-sectional view of the steam-cleaning device of FIG. 1, showing different illustrative aspects thereof.

FIG. 3 is a magnified perspective view of the bottom of a pressure vessel of the steam-cleaning device in accordance with a preferred embodiment of the present invention.

FIG. 4 is a magnified perspective view of a power base station of the steam-cleaning device in accordance with a preferred embodiment of the present invention.

FIG. 5 is an electronic circuit diagram of the steam-cleaning device in accordance with a preferred embodiment of the present invention.

FIG. 6 is partial cross-sectional perspective view of a pressure vessel enclosure of the steam-cleaning device in accordance with a preferred embodiment of the present invention.

FIG. 7 is a partial cross-sectional side view of a pressure vessel enclosure of the steam-cleaning device in accordance with a preferred embodiment of the present invention.

FIGS. 8A-B are partial cross-sectional side views of a pressure vessel enclosure of the steam-cleaning device in accordance with a preferred embodiment of the present invention.

FIG. 9 is a partial cross-sectional perspective view of a steam-cleaning device in accordance with a main preferred embodiment of the present invention.

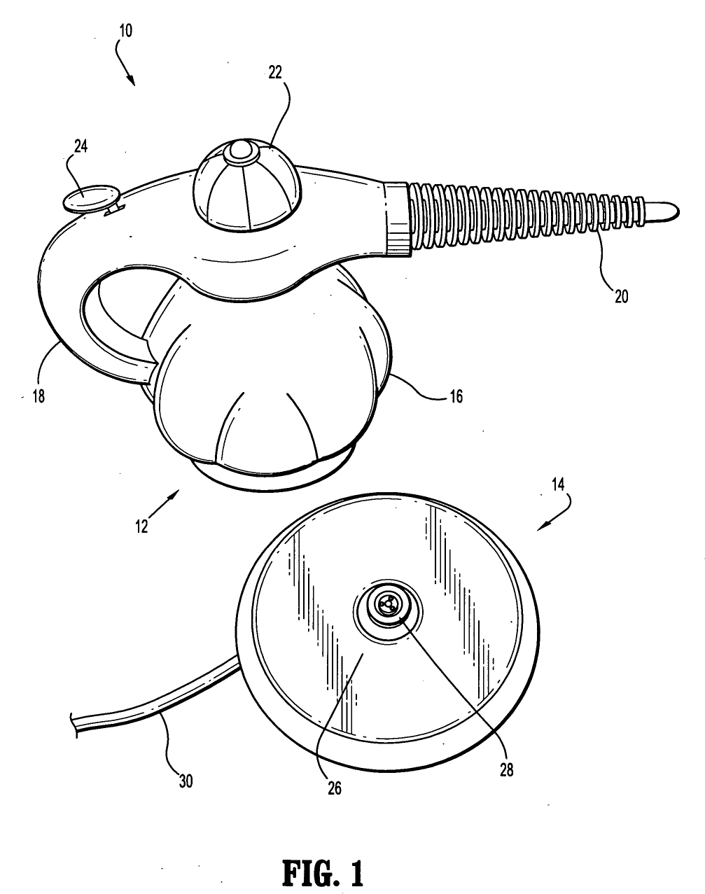

FIGS. 1 OA-B are partial cross-sectional top views of a steam-cleaning device in accordance with a main preferred embodiment of the present invention.

### DETAILED DESCRIPTION OF THE INVENTION

FIG. 1 shows a steam-cleaning device 10 in accordance with a preferred embodiment of the present invention. The steam-cleaning device includes a steam pressure vessel 12 and a power base station 14. The steam pressure vessel 12 can be ergonomically shaped and include a body 16, a handle 18, one of many cleaning attachments, such as in the form of a nozzle 20 for example, and a pressure relief valve cap 22. Located on the handle 18 can be a trigger 24 to enable a user to release steam from the nozzle 20.

The power base station 14 preferably has a support plate 26 to support and hold the steam pressure vessel 12, a vessel plug 28 into which the steam pressure vessel 12 can be connected to reheat the water into steam, as well as a power cord 30. The power cord 30 can be a standard manually wound power cord, used with, for example, a cord storage bobbin 31 or can be a retractable cord in the form of an automatic cord storage reel (not shown).

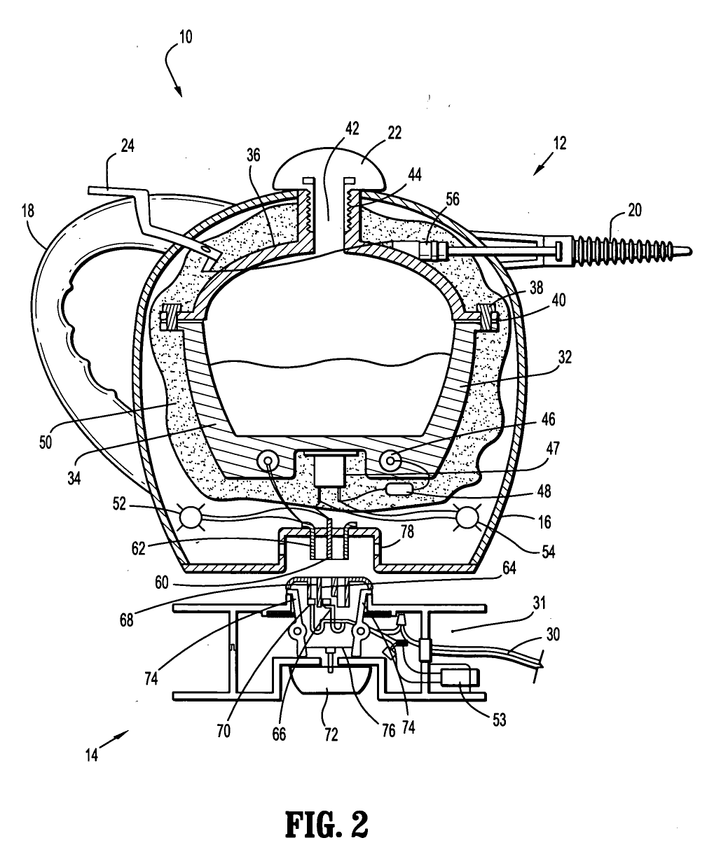

FIG. 2 shows a cross-sectional view of the preferred embodiment for a steam-cleaning device 10. The steam-cleaning device 10 contains a steam pressure vessel 12 with a steam pressure vessel enclosure 32 that holds water to be boiled into steam. The pressure vessel enclosure 32 can be, for example, a large die cast pressure vessel boiler or a stainless steel boiler. In one embodiment, the pressure vessel enclosure 32 can be a stainless steel boiler with a die cast heater, wherein the die cast heater is fastened to, molded to or in intimate contact with the stainless steel boiler. Preferably, the vessel enclosure 32 can be comprised of a lower enclosure 34 and an upper enclosure 36 fastened together by a bolt 38 and sealed with an enclosure gasket 40. The upper enclosure 36 can have an inlet port 42 for filling the vessel enclosure 32 with water. The inlet port 42 preferably has threads that can receive matching threads on the pressure relief valve cap 22. This can enable the pressure relief valve cap 22 to be secured into the vessel enclosure 32 by being screwed into the upper enclosure 36. This allows steam pressure to build up and be released through the nozzle 20 when the trigger 24 is depressed.

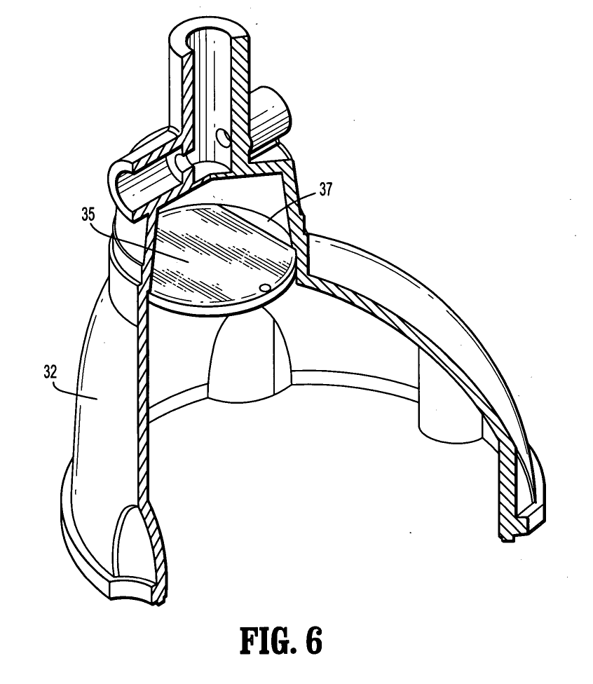

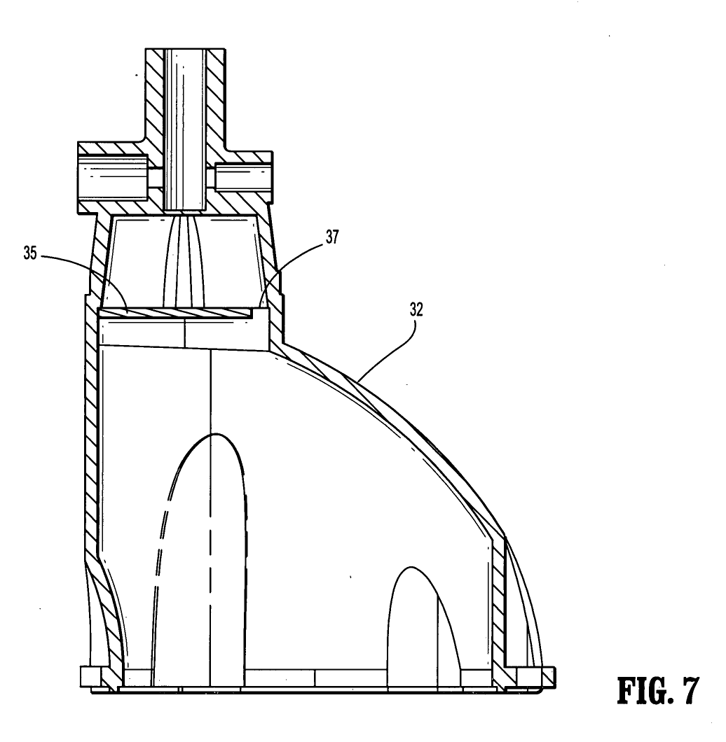

FIGS. 6-8 show a preferred embodiment for the pressure vessel enclosure 32 to include a baffle plate 35. The steam pressure vessel 12 can be shaped in a way that enables the handle to be closer to the center of gravity. This will reduce the tendency of the center of gravity to cause the steam pressure vessel 12 to tip forward in an undesirable way. However, when the steam pressure vessel 12 is tipped forward past a particular threshold, there is a tendency for the water to flow out from the vessel enclosure 32 and onto the surface being cleaned. To prevent this from occurring, a baffle plate 35 can be used to prevent the water from flowing out. The baffle plate 35 generally obstructs the water from leaving the pressure vessel enclosure 32 as the steam pressure vessel 12 is tipped forward. A baffle plate opening 37 enables the steam to flow out toward the surface to be cleaned, while substantially preventing the water from also flowing out.

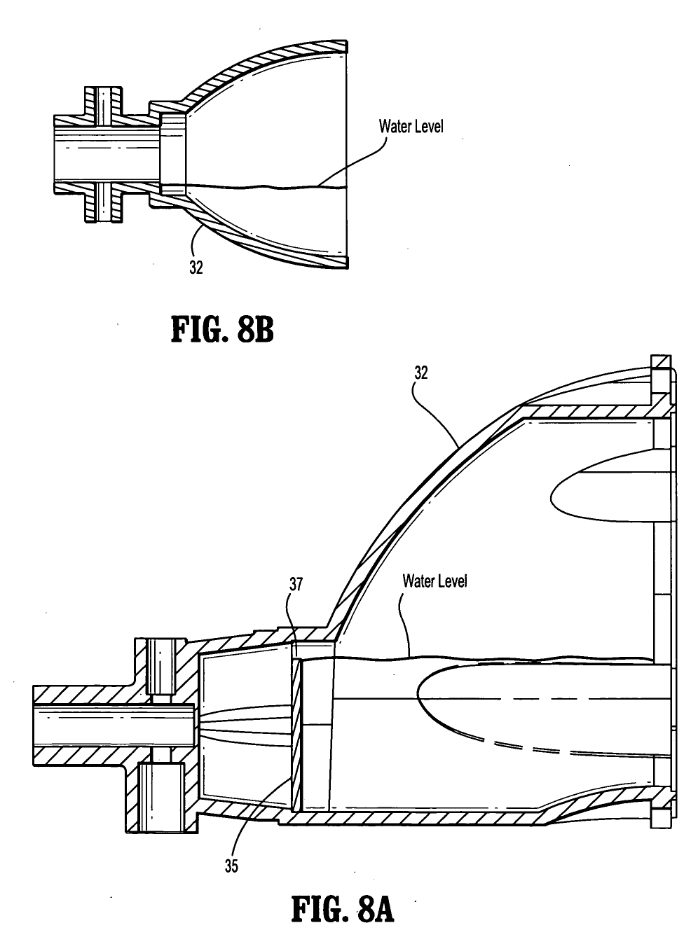

This baffle plate 35 is typically screwed into the vessel enclosure 32. However, other methods, such as molding, soldering, gluing or other fastening methods are also contemplated. FIG. 8A shows an example of the water level that can be reached without spilling when the steam pressure vessel 12 has this baffle plate 35. FIG. 8B shows an example of the water level that can be reached before spilling when the steam pressure vessel 12 does not contain the baffle plate 35.

As shown in FIG. 2, the water in the vessel enclosure 32 can be heated and brought to a boil by one or more tubular heaters or calrods 46. In one embodiment, the heaters 46 can be in the form of a large aluminum die cast tubular heater assembly. The temperature can be regulated through the use of an automatic thermostatic control 47. A thermal fuse 48 can be incorporated in as a safety mechanism for the device 10 to protect against overheating. When the boiling water is converted into steam and a mass of heated water, it can be kept in a pressurized condition by the large mass of the boiler pressure vessel as well as a thermally insulated blanket 50 made of high temperature insulation.

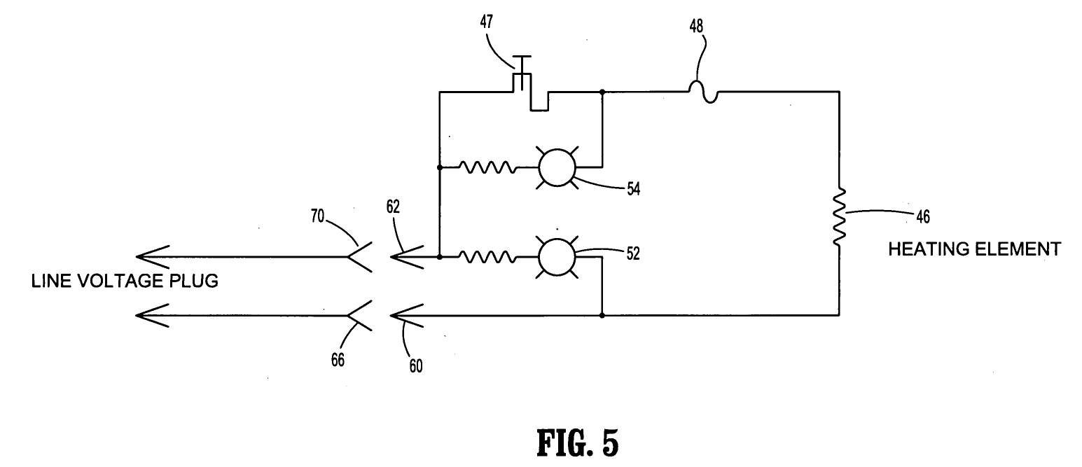

The status of the steam-cleaning device 10 can be indicated through the use of indicator lights. For example, the device 10 can include a power light 52 to indicate whether the device is on or off, depending on the position of a power switch 53. The device 10 can also include a ready light 54 to indicate whether the device 10 is ready to emit steam from the nozzle 20 for cleaning. FIG. 5 shows an electronic circuit diagram for the preferred embodiment of the present invention.

In the preferred embodiment, the steam is released by a precision, trigger actuated mechanical linkage valve system 56 that releases a precise amount of steam through the nozzle 20 on demand and to the desired location by the operator. When the trigger is released, the steam flow immediately stops and the pressure vessel enclosure mass, water and thermal insulating blanket 50 keeps the steam at the proper operating temperature for continued on demand use. In an alternate embodiment, the trigger can be actuated by an electronic valve system (not shown). The steam-cleaning device 10 announces that it is ready for refresh or water replacement by reducing the amount of steam released when the ready indicator light 54 is on and when the trigger steam valve 56 is actuated without steam being emitted from the nozzle 20.

The steam-cleaning device 10 utilizes a power base station 14 working in conjunction with the steam pressure vessel 12 to allow for a “cord, cordless” system that can eliminate the limitations of a power cord and keep the vessel enclosure 32, water and steam at the proper temperature for an extended period of time for spot cleaning or cleaning in a relatively small area. The vessel enclosure 32, water and steam can be easily reheated for continued use by placing the pressure vessel 12 on the power base station 14. The power base station 14 supplies power to the heater assembly 46 in order to use water to make steam in the pressure vessel 12, as well as serving as a steam reheat station and cord keeper.

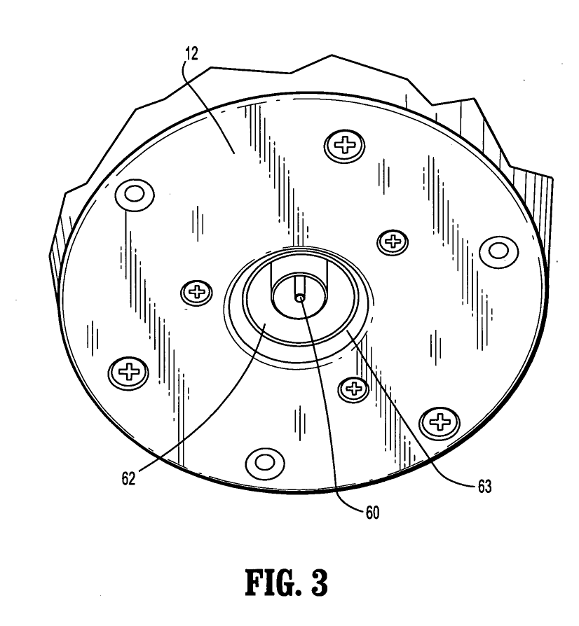

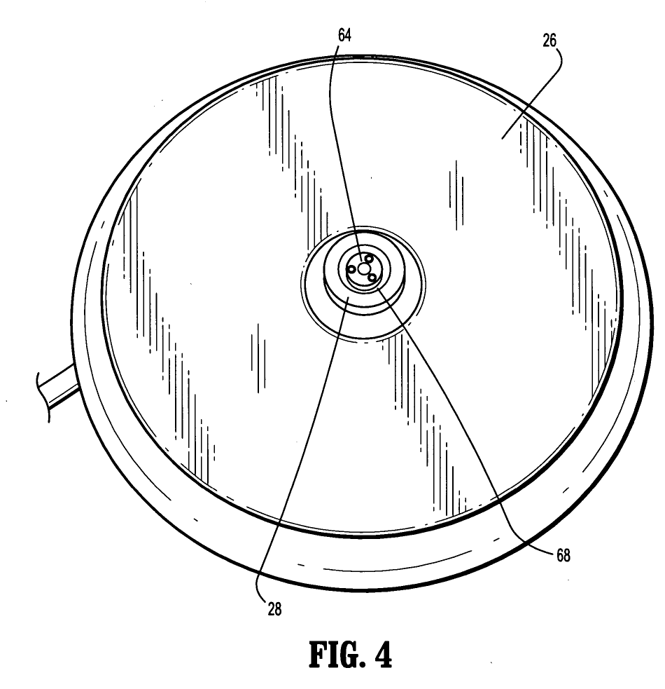

To reheat the pressure vessel 12, the pressure vessel is placed upon the vessel plug 28 on the support plate 26 of the power base station 14. Located on the bottom of the pressure vessel 12 are preferably a male fixed center pin contact 60 and a male fixed ring contact 62. When the pressure vessel 12 is placed on the power base station 14, the male fixed center pin contact 60 enters a center base port 64 to come into contact with a female, spring loaded, center electrical contact 66. Simultaneously, the male fixed ring contact 62 enters a ring base port 68 to come into contact with a female, spring loaded, outer electrical contact 70. This enables the pressure vessel 12 to be placed upon and removed from the power base station 14 repeatedly with ease. The bottom of the pressure vessel 12 is also illustrated in FIG. 3, showing a male fixed center pin contact 60 and a male fixed ring contact 62. In an alternate embodiment of the present invention, the pressure vessel 12 can also include an additional ground 63.

The support plate 26 with vessel plug 28 is also illustrated in FIG. 4, showing the center base port 64 and ring base port 68. The power base station 14 allows the portable cordless steamer to use the steam refresh option and to plug into the power base station 14 in a three hundred and sixty degree insertion position on a horizontal plane such as found on a counter top or vanity. The present invention also contemplates the use of other arrangements besides a pin/ring configuration to accomplish the same result. Any method of enabling male contacts to easily come into contact with female contacts can be utilized.

The power base station 14 is also capable of being selectively locked onto the pressure vessel 12 by a captured locking lever cam system that can enable the steam-cleaning device 10 to be used in a continuous operation for large cleaning areas. This can be accomplished though the use of a locking knob 72. The locking knob 72 actuates locking tab levers 74 by rotating a cam 76. The cam 76 preferably moves the locking tabs 74 inward toward the center in order to lock the power base station 14 to the portable pressure vessel 12. When the locking knob 72 is rotated, the cam 76 is rotated along with the locking tabs 74. This positions the ends of the locking tabs 74 into locking slots 78 located near the bottom of the pressure vessel 12. In order to unlock the power base station 14 from the pressure vessel 12, the locking knob 72 is rotated in the reverse direction. In an alternate embodiment, the steam-cleaning device 10 may use a cord, cordless floor system with a roll-around cradle that would contain the portable boiler system.

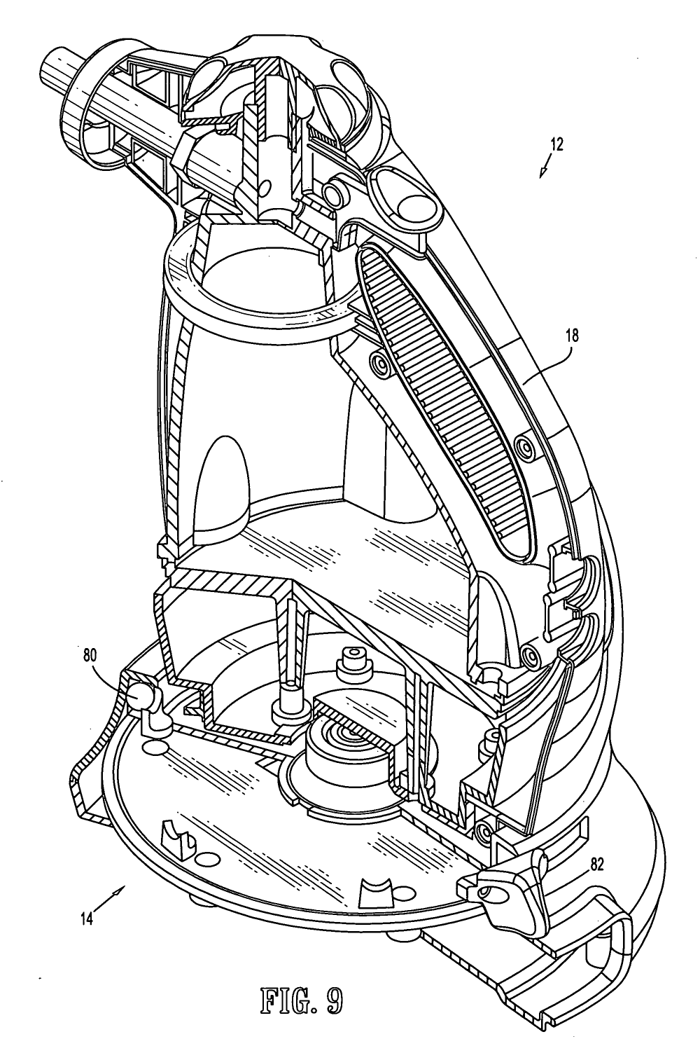

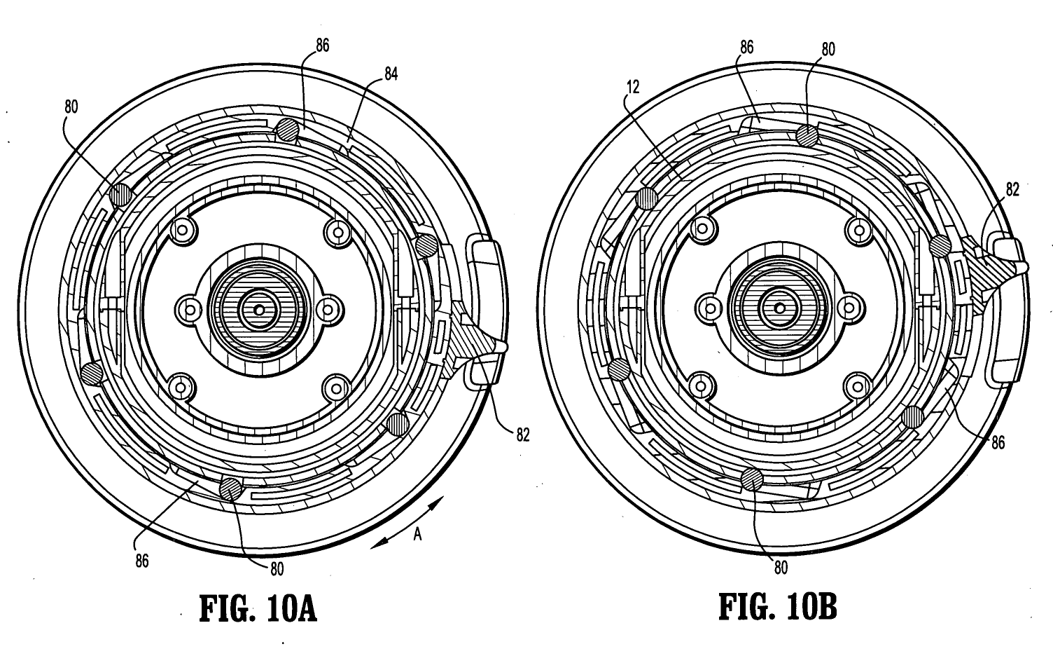

In another main embodiment, the pressure vessel 12 can be selectively locked and unlocked from the power base station 14 through the use of a sphere/ring method. This is illustrated in FIGS. 9 and 10, showing the locking spheres 80 and lever 82. The spheres 80 are obstructed from moving in direction A. The spheres are only capable of moving in a radial direction (i.e., toward or away from the center of the power base station 14). When the lever 82 is in the unlocked position, as shown in FIG. 10A, the spheres 80 are not locked inward by the ring 84, and are generally in an outer position. The pressure vessel 12 can be selectively replaced and removed from the power base station 14.

When the pressure vessel 12 is placed on the power base station 14 and the lever 82 is moved to the locked position, as shown in FIG. 10B, the ring 84 rotates along with the lever 82 and ramps 86 in the ring 84 press the corresponding spheres 80 in toward the pressure vessel 12. This prevents the pressure vessel 12 from being removed. To release the pressure vessel 12, the lever 82 is then moved back to the unlocked position. The ring 84 rotates back to its original position, along with the ramps 86, thereby enabling the spheres to move back away from the pressure vessel 12 to their original positions. The pressure vessel 12 is then capable of being removed.

While a preferred embodiment of the invention has been herein disclosed and described, it is understood that various modifications can be made without departing from the scope of the invention.

What is claimed is:

1. A steam cleaning device comprising:
a steam pressure vessel comprising a body, a handle and a cleaning attachment;
a heater within said steam pressure vessel to boil water into steam; and
a power base station adapted to support and releasably hold said steam pressure vessel and to provide power to said heater when said steam pressure vessel is connected to said power base station.

2. A steam cleaning device according to claim 1, wherein
said steam pressure vessel can be selectively used with or without being attached to said power base station.

3. A steam cleaning device according to claim 1, further comprising
a trigger on said body enable a user to selectively release said steam from said steam pressure vessel.

4. A steam cleaning device according to claim 1, wherein
said cleaning attachment is a nozzle.

5. A steam cleaning device according to claim 1, further comprising
a pressure relief valve cap secured to said body to allow pressure to build up within said body.

6. A steam cleaning device according to claim 1, further comprising
a plate to prevent water from flowing out of said body when said steam pressure vessel is tipped forward.

7. A steam cleaning device according to claim 1, wherein
said steam pressure vessel is shaped whereby the center of gravity of said vessel is near said handle.

8. A steam cleaning device according to claim 1, further comprising
a captured locking lever cam system to enable said pressure vessel to be selectively locked to said power base station.

9. A steam cleaning device according to claim 1, further comprising
a sphere and ring system to enable said pressure vessel to be selectively locked to said power base station.

10. A steam cleaning device according to claim 1, further comprising
a retractable cord connected to said power base station to provide power to said steam cleaning device.
